(19) United States
(12) Patent Application Publication
(10) Pub. No.: US 2026/0126358 A1
(43) Pub. Date: May 7, 2026

(54) Rapid vitrification of biological samples

(71) Applicant: New York Structural Biology Center, New York, NY (US)

(72) Inventor: Alex de Marco, Englewood Cliffs, NJ (US)

(21) Appl. No.: 19/381,529

(22) Filed: Nov. 6, 2025

Related U.S. Application Data
(60) Provisional application No. 63/717,710, filed on Nov. 7, 2024.

(51) Int. Cl. G01N 1/42

(52) U.S. Cl. CPC G01N 1/42

(57) ABSTRACT

A method of sample preparation in association with an electron microscope. In one embodiment, a carrier supporting a biological sample is received. A high-pressure freezing (HPF) protocol is then applied to the carrier. The protocol comprises a first phase, and a second phase that follows the first phase. The first phase comprising (i) comprising: a pressurizing operation applying a pressure to the carrier, and (ii) a rapid cooling operation using a coolant that avoids a Leidenfrost effect at a carrier-coolant interface by maintaining nucleate boiling or substantially suppressing film boiling upon contact with the carrier. The pressurizing and rapid cooling operations freeze the biological sample while preserving its structural integrity. The second phase involves raising a temperature of the carrier and the frozen biological sample to a given temperature for one of: storage, and use.

### BACKGROUND

The subject matter herein relates generally to the field of biological sample preparation and preservation techniques. More particularly, the subject matter concerns methods and apparatus for high-pressure freezing (HPF) of biological specimens for subsequent microscopic examination and analysis.

Single particle cryo-Electron Microscopy (cryo-EM) revolutionized structural biology, enabling resolution of the structure of molecules in a purified near-native condition, as well as resolution of dynamics in large complexes that were, up until a few years ago, impossible to analyze. Cryo-electron tomography (cryo-ET) is a technique akin to a single particle that recently emerged as an enabler for performing structural analyses directly in the cell, where biology occurs without purification. Cryo-ET provides snapshots of the cellular landscape, revealing the spatial relationships between macromolecules, organelles, and other cellular structures in their native state at molecular resolution. It bridges this gap between isolated molecular structures and cellular context.

The preservation of biological samples (or more generally aqueous samples) in their native state is crucial for structural and functional studies at the cellular and molecular level using cryo-EM or -ET systems. Traditional chemical fixation methods often introduce artifacts and fail to capture the true ultrastructure of biological specimens. This limitation has driven the development of physical preservation methods, particularly those employing rapid freezing techniques.

High-pressure freezing (HPF) was developed for aqueous sample preservation in the 1960s. The technique involves the application of high pressure (approximately 2100 bar) during the freezing process, which prevents the formation of crystalline ice and instead promotes the formation of vitreous ice. This vitrification process is essential for maintaining the structural integrity of biological samples.

Conventional freezing methods at atmospheric pressure are limited by the formation of crystalline ice structures. Even if a sample is plunged in liquid ethane (T˜80K) the water will transition from liquid to crystalline if the thickness is higher than 10um.

The phase diagram of water reveals that at typical ambient conditions on Earth (approximately 0.1 MPa), cooling results in the formation of hexagonal ice (Ice Ih). This crystallization process causes mechanical stress through volume expansion and chemical alterations within the sample, leading to structural artifacts and compromised analysis. While cryoprotectants can modify this process, traditional freezing methods cannot completely prevent crystalline ice formation in samples thicker than a few micrometers. Moreover, the phase diagram demonstrates that different crystalline ice forms emerge in distinct regions of pressure-temperature space: at atmospheric pressure and temperatures below 0°C, Ice Ih is the stable phase, which is particularly problematic for biological preservation due to its hexagonal crystal structure.

The application of high pressure during freezing addresses these limitations by exploiting water's complex phase behavior to promote vitrification rather than crystallization. The water phase diagram reveals multiple triple points where three phases can coexist, with the liquid-Ice Ih-Ice III triple point occurring at 209.9 MPa and -22°C (251.15K), and the liquid-Ice V-Ice VI triple point at 632.4 MPa and 0.16°C. High-pressure freezing typically operates at pressures around 2100 bar (210 MPa), strategically chosen near the liquid-Ice Ih-Ice III triple point. At these conditions, rapid cooling can bypass the formation of any crystalline ice phases (including Ice III and Ice V) through a pressure-induced vitrification process. This process is governed by two primary mechanisms: first, the increased pressure alters water's phase transitions, as evidenced by the phase diagram's liquid water region extending to lower temperatures under pressure. Second, the combination of pressure and rapid cooling rates (>10,000°C/s) promotes the formation of amorphous ice, where water molecules maintain a disordered, liquid-like arrangement. The transition between low-density amorphous (LDA) and high-density amorphous (HDA) forms of ice occurs in this pressure regime, with evidence suggesting a second critical point in the phase diagram associated with this transition. However, this remains subject to experimental verification.

The phase diagram reveals that at pressures above 209.9 MPa, water can transition through multiple crystalline phases (Ice III, V, and VI) depending on the specific pressure-temperature path. High-pressure freezing protocols must therefore be carefully designed to avoid these crystalline phases, as their formation would compromise sample preservation. This is achieved by selecting pressure-temperature conditions and cooling rates that favor direct vitrification while avoiding the thermodynamically stable crystalline phases shown in the phase diagram.

Current HPF methods typically employ dedicated instruments that cool samples under high pressure using liquid nitrogen as the primary coolant. These systems generally achieve cooling rates of 10,000-20,000°C/s and can successfully vitrify samples up to approximately 200 micrometers in thickness. However, existing HPF techniques face limitations due to sample size restrictions and heat transfer limitations.

Therefore, there remains a significant need in the art for improved HPF methods and apparatus that can overcome these limitations while maintaining or enhancing the quality of sample preservation. Such improvements would have substantial impact across multiple fields, including cell biology, neuroscience, and materials science.

HPF technology, crucial for preserving thick samples, has remained unchanged since its commercial introduction, limiting preservation quality and sample thickness. Relatedly, the sample carriers used in high pressure freezing prioritize manufacturing simplicity over thermal efficiency, resulting in sub-optimal vitrification.

### SUMMARY

This disclosure provides for new HPF methods and improvements to sample carriers to provide for enhanced and modernized high-pressure freezing technology. Taken together, these advances bring sample preparation capabilities in line with modern imaging technology, enabling more efficient and reliable structural biology studies.

The foregoing has outlined some of the more pertinent features of the disclosed subject matter. These features should be construed to be merely illustrative. Many other beneficial results can be attained by applying the disclosed subject matter in a different manner or by modifying the subject matter as will be described.

### BRIEF DESCRIPTION OF DRAWINGS

FIG. 1 depicts a known high-pressure freezing (HPF) approach to sample preparation;

FIG. 2 depicts a thermodynamic simulation of the time required to cool a standard-size HPF sample to cryogenic temperature using alternative coolants (as described below) versus liquid nitrogen;

FIG. 3 depicts the HPF freezing protocol according to the techniques of this disclosure; and

FIG. 4 depicts a cryo-EM system.

### DETAILED DESCRIPTION

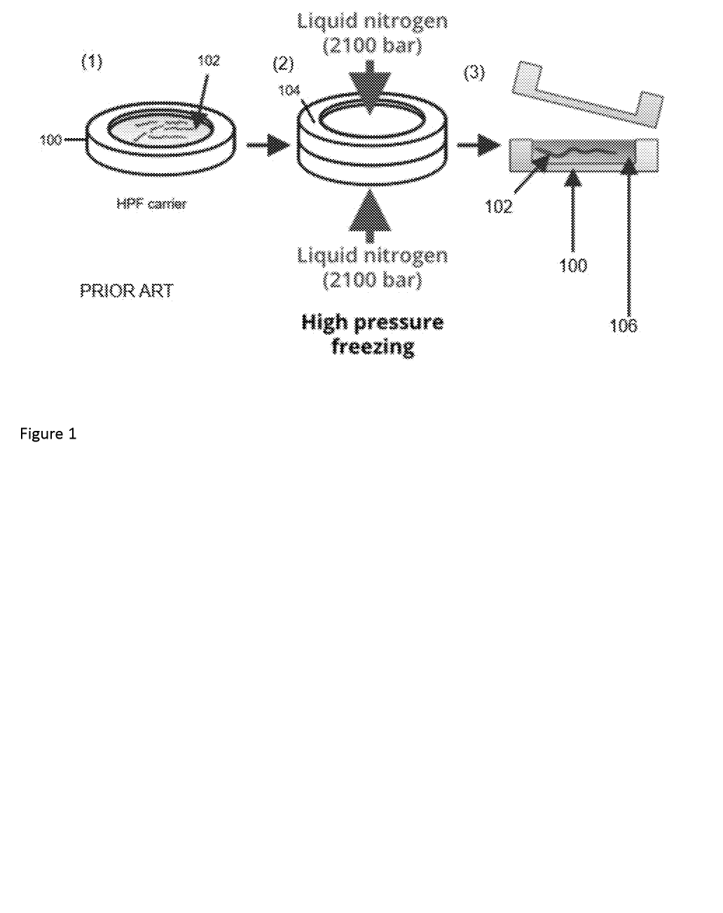

As is known in the art, the vitrification of an aqueous specimen typically comprises isolating the biological sample, e.g., a purified protein complex, applying it to a support structure (a grid), reducing its dimension to a layer that is as thin as possible based on the size of the biological molecule, and then freezing this layer fast enough to prevent the water from crystallizing. FIG. 1 depicts this approach. At step (1), the biological material 102 and a filter are placed within a carrier 100, which may be formed of a suitable material such as aluminum, copper, gold, silver, or the like. In step (2), the carrier 100 is sealed with an overlaid (empty) carrier 104, and high pressure freezing (HPF) is carried out using liquid nitrogen (LN₂). In this example, which also represents the state-of-the-art, the carrier is position-able or otherwise received in a sealed chamber, and the liquid nitrogen is used to both pressurize and simultaneously cool the sample. To that end, and in a representative implementation, pressure (e.g., at 2100 bar) is applied to the sealed carrier, which is then subjected to a jet LN₂ spray (or, in the alternative, to plunge freezing), to cool the sample to liquid nitrogen temperature. The pressurization and cooling operations may be carried out concurrently. The sequencing typically is under precise programmatic control. At step (3), which represents the output of the above-described HPF preservation process, the frozen sample 102 is shown embedded in vitreous ice 106 in the carrier 100. For cryo-EM or ET evaluation, the overlaid carrier 104 is typically removed as depicted. This sample preparation protocol is enhanced as now described.

The first aspect of this disclosure is an adjusted freezing protocol that substantially increases the rate of heat extraction from the sample. As will be seen, the protocol facilitates precise control over tissue sampling while ensuring sample integrity throughout preparation. The approach also ensures that samples remain unaltered by cryo-protectants or fixatives. Further, protocol reliably vitrifies samples up to, e.g., 200μm thick, with extension to 300μm or thicker.

The physics of heat extraction defines certain constraints. In particular, a standard HPF sample requires the removal of 0.216 J of heat to reach equilibrium at 77K using liquid nitrogen, taking approximately 1.77 seconds. To reduce this time, and according to the first aspect of this disclosure, the freezing protocol preferably is implemented in association with a system wherein pressure generation is decoupled from the cooling circuits in the cryo-EM or ET system. In particular, and in lieu of using the coolant to also pressurize the sample carrier, preferably cooling and pressurization use different methods and materials. Building on early HPF designs that used mechanical pressure generation separate from cooling, the freezing protocol herein leverages one or more efficient coolants as compared to liquid nitrogen, which as noted above is the current state-of-the-art. To that end, and in one embodiment, and to optimize heat transfer during freezing, the coolant is one of: liquid helium, which offers a heat transfer coefficient four times (4X) higher than liquid nitrogen (80K), and a supercooled fluid such as slush nitrogen, which as compared to LN₂ provides 40% higher heat transfer efficiency while remaining cost-effective and readily available. Slush nitrogen is a two-phase fluid (a mixture of solid nitrogen and liquid nitrogen) that contains solid particles. The presence of these particles improves convective heat transfer by creating a steeper temperature gradient and promoting fluid flow. Other alternative coolants include liquid neon and liquid propane, and combinations of the above-identified coolants. These coolants have the advantage of a higher heat transfer coefficient (HTC) than that of liquid nitrogen, and the lower coolant temperature provides significant gains regarding the final heat transfer rate. Generalizing, a heat transfer coefficient is a measure of the rate of heat transfer between a fluid and a surface. It is a proportionality constant used to calculate how much heat is transferred per unit of area and per degree of temperature difference between the surface and the fluid. The value of this coefficient depends on fluid properties (like density, viscosity, and conductivity), flow conditions, and the surface geometry. Here, the above-identified alternative coolants have higher HTCs than does liquid nitrogen, and they operate effectively across different sample thicknesses and compositions. Their use in the freezing protocol here enables much faster heat extraction as compared to existing LN₂-based techniques. Once the initial heat transfer from the carrier (and the biological sample) has been accomplished, and according to a further aspect of the protocol, the temperature of the carrier (and the sample) is then raised, e.g., to that of liquid nitrogen, for storage and use. Raising the temperature is accomplished in one of several ways, e.g., adding LN₂ at atmospheric pressure to the slush nitrogen, moving the carrier to an LN₂ bath, or the like.

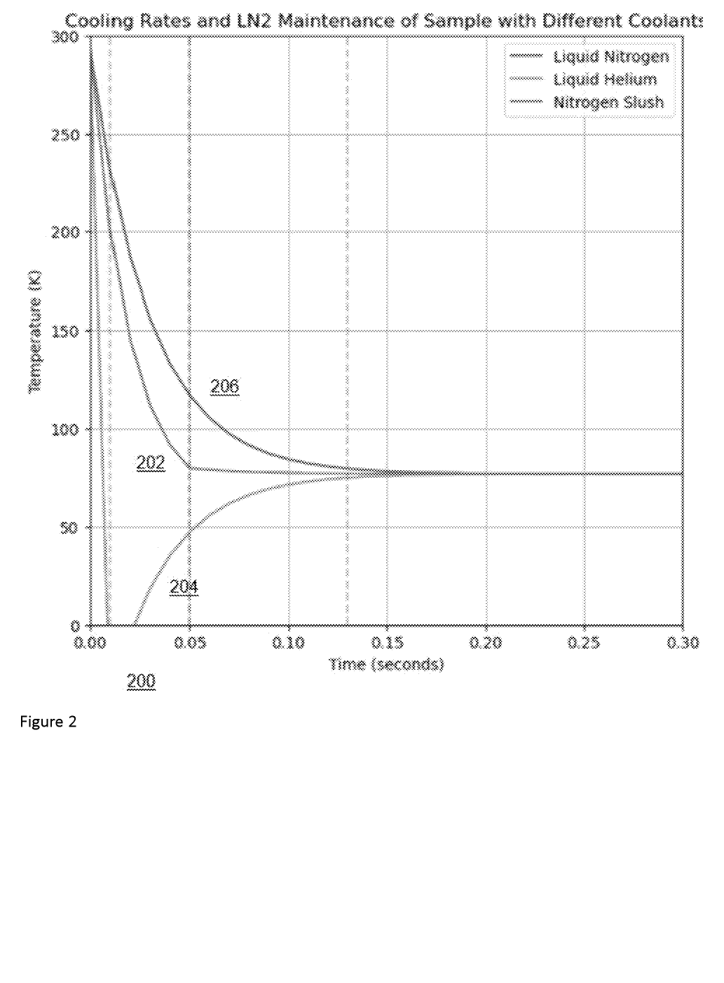

FIG. 2 is a graph that depicts the advantages of using an alternative coolant (in this example, either liquid helium or nitrogen slush) as compared to the prior art. In particular, the graph 200 depicts a thermodynamic simulation of the time required to cool a standard size HPF sample (1.5 x 0.2 mm, such as shown in FIG. 1) to cryogenic temperature using the identified alternative coolants (nitrogen slush or liquid helium) and keeping the temperature using liquid nitrogen. As depicted, nitrogen slush (curve 202) or liquid helium (curve 204) provide faster and thus more efficient heat extraction as compared to liquid nitrogen (curve 206). In one particular embodiment, nitrogen slush, obtained by lowering liquid nitrogen's pressure until it reaches 62K, is utilized for high-pressure freezing, as it offers a practical balance between improved performance and accessibility.

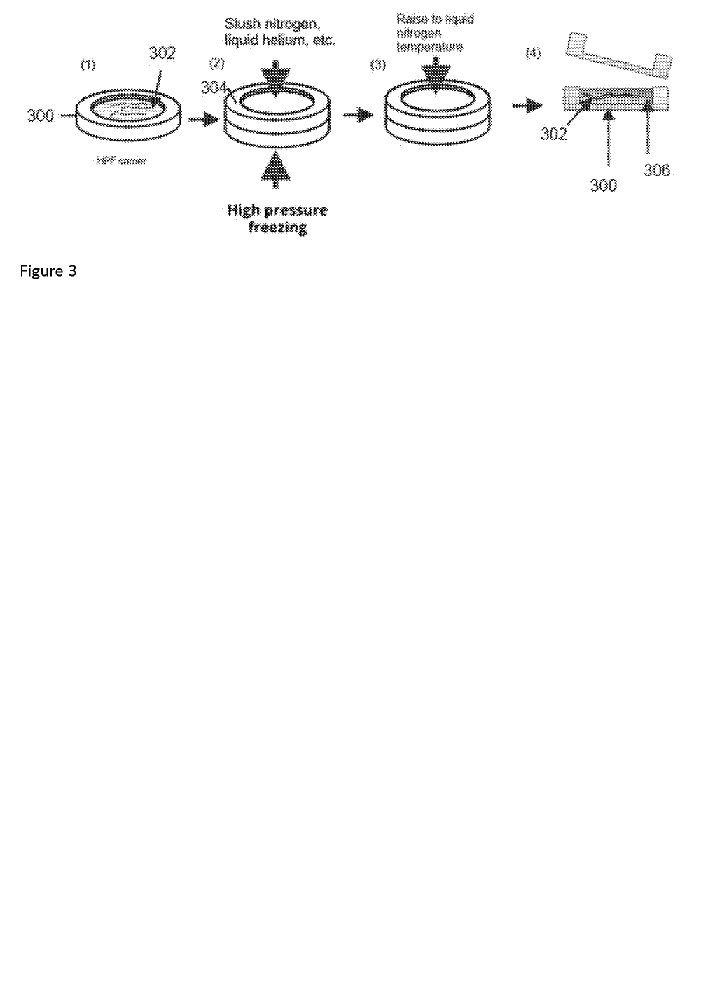

FIG. 3 depicts the HPF protocol of this disclosure. For illustrative purposes as compared to FIG. 1, at step (1) the biological sample of interest 302 is again supported in carrier 300, which is then sealed using the empty carrier 304. This configuration is not intended to be limiting, as the biological sample may be supported in other ways. For example, the sample may be retained in a sample holder that itself is configured to be reciprocated into a sealable chamber in which the pressure and the coolant are applied. At step (2), the sealed carrier is subjected to high pressure and is then, within milliseconds, subjected to rapid cooling, e.g., using the alternative coolant.The pressurization and cooling operations may also be applied concurrently. Preferably, and as noted above, different techniques and materials are used to accomplish the pressure and the rapid cooling. In this embodiment, the coolant is slush nitrogen, and the pressure is applied from a compressed air source, a mechanical force generating device or system that applies a jet of a pressurized fluid, or the like. Typically, the pressure applied is in the range of 1800 – 2400 bar, with 2100 bar being a preferred pressure. These operations are carried out under programmatic control, and, as noted, with application of pressure preceding or occurring concurrently with the rapid cooling. At step (3), the sealed carrier is brought back to a higher temperature, e.g., the temperature of liquid nitrogen, for storage and use. The use is depicted at step (4), with the overlaid carrier removed, thereby exposing the frozen sample 302 embedded in vitreous ice 306 in the carrier 300 that is then position-able within the cryo-EM or -ET system.

The following provides additional details regarding the alternative coolants. By way of additional background, a significant limitation of using liquid nitrogen as a primary coolant is the Leidenfrost effect, which occurs when a liquid comes into contact with a surface significantly hotter than its boiling point. In conventional HPF, the relatively warm sample carrier (e.g., at 300K) instantly vaporizes the 77K liquid nitrogen at the interface, creating an insulating vapor layer. This phenomenon, known as film boiling, dramatically reduces the heat transfer coefficient (HTC) and slows the cooling process. As is known in the art, existing systems attempt to mitigate this by using a high-velocity jet spray of LN2, often at 5 bar or more. While this high pressure partially disrupts the insulating vapor barrier, it does not eliminate film boiling and cannot change the intrinsic, and relatively limited, heat absorption capacity of liquid nitrogen (specific heat capacity of approx. 2.04 J/g·K at 77K).

The techniques herein overcome this limitation by using coolants that operate via a different heat transfer mechanism. In one embodiment, the coolant is slush nitrogen. Slush nitrogen, a two-phase mixture of solid and liquid nitrogen at its triple point (63K), provides two distinct advantages. First, its lower temperature provides a larger temperature gradient for heat transfer. Second, and more importantly, the solid nitrogen particles within the liquid act as a high-capacity heat sink, absorbing heat via the latent heat of fusion (approx. 25.7 J/g). This effective heat capacity, which is released as the solid particles melt, is vastly greater than the sensible heat capacity of liquid nitrogen alone and allows for the absorption of large amounts of heat while maintaining a constant temperature. This process suppresses film boiling and promotes highly efficient nucleate boiling, resulting in a much higher HTC than pure LN₂.

In another embodiment, the coolant is a subcooled liquid such as liquid propane. Liquid propane possesses a higher specific heat capacity (approx. 2.4 J/g·K at 100K) than liquid nitrogen (approx. 2.04 J/g·K). It is used as a stable, subcooled liquid by pre-chilling it to a working temperature between 80K and 120K. When, for example, the sample carrier is plunged into this subcooled propane, heat is transferred via single-phase liquid convection. Because the coolant is far from its boiling point (231K), the Leidenfrost effect and film boiling are eliminated, allowing for an extremely rapid and stable heat extraction rate driven by the liquid's higher heat capacity.

Thus, an alternative coolant as specified herein avoids the Leidenfrost effect at the carrier-coolant interface by maintaining nucleate boiling or substantially suppressing film boiling upon contact with the carrier. The coolant has a specific heat capacity greater than the specific heat capacity of liquid nitrogen, and preferably a temperature at or below 120K and a specific heat capacity greater than that of liquid nitrogen.

In addition to optimizing heat transfer during freezing, another aspect of this solution provides that the sample carrier is formed of a material for optimized vitrification. As noted above, current carriers, shaped and manufactured for simplicity rather than optimal performance, limit heat transfer during vitrification. Typically, and as shown in FIG. 1, a carrier has a cup-like form factor with an open top for receiving the biological sample, and it is formed of aluminum, gold, gold-plated aluminum, or the like. A structure of a similar shape (or a flat plate) is then used as a seal to close the carrier before the high pressure is applied. According to this disclosure, this structural configuration is modified to utilize advanced materials, which afford better thermal conductivity. In one example embodiment, the carrier (e.g., element 300 in FIG. 3) is manufactured out of a ceramic, such as silicon carbide (SiC). For example, high-purity SiC provides higher thermal conductivity as compared to copper. Alternative materials for the carrier may include, without limitation, synthetic diamonds, which provide up to 5X higher thermal conductivity than copper.

Alternative shapes of the carrier can include the presence of structures that penetrate in the sample area to increase the heat-sink efficiency or the use of multiple, smaller chambers to improve the reproducibility of the freezing process despite being at the cost of the final sample volume.

### Additional technical details and application environment

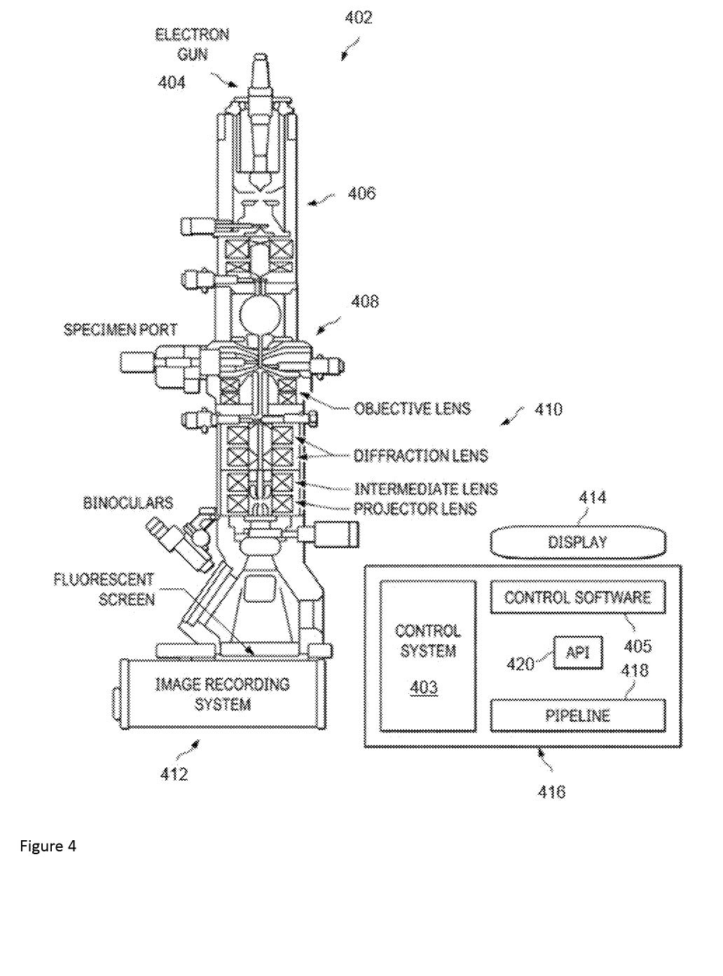

The sample preparation and preservation techniques herein may be practiced in or in association with a cryo-EM or -ET system. FIG. 4 depicts a representative cryo-EM system. The system comprises a transmission electron microscope 402, and an associated control system 403 configured to control the position of the microscope 402 relative to a target being examined, in this case a biological sample that has been prepared and preserved in the manner described herein. Control system 403 includes microscope control software 405, such as Leginon (Simons Electron Microscopy Center, New York Structural Biology Center), SerialEM (University of Colorado Boulder), Thermo-Fisher® EPU, and the like. For imaging, microscope 402 comprises an electron source 404 that emits a beam of electrons, an electromagnetic lens system 406 that focuses the beam of electrons down to a nanometer scale, a sample holder 408 that holds a sample to be observed (e.g., within a stage), a series of electromagnetic lenses 410 that transmit the electrons through the sample, a series of detectors 412 that are configured to detect the electrons as they are transmitted through the sample, a display 414 configured to display an image of the sample based on the detected electrons, and a computing system 416 (including microscope control software 405) configured to control the operation of the electron source, the electromagnetic lenses, the detectors, and the display. The system may also include a software-based pipeline 418 that uses neural network models and computer vision algorithms to navigate cryo-EM grids at low- and medium-magnification to determine high-quality targeting locations for the microscope, preferably without human input. The models may comprise both pre-trained neural network models, together with models that provide learning on-the-fly during an active data collection. In this example, the software pipeline 418 is supported in a data store or memory of the computing system 416 and interoperates with the microscope control software 405 over an Application Programming Interface (API) 420. In an alternative, the software pipeline 418 is integrated directly into the microscope control software 405 in the computing system. The pipeline may be built into the microscope control software system, or operated in association with that control system, all as previously described.

Further details regarding representative cryo-EM or -ET systems and in which the techniques of this disclosure may be practiced are described in U.S. Patent Nos. 12,057,289 and 12,205,789, the disclosures of which patents are hereby incorporated herein by reference. Although not intended to be limited, the freezing protocol herein may be implemented in a dedicated high-pressure freezer (HPF) device or system. The system typically includes a robotic arm assembly or subsystem comprising a multi-jointed, motorized manipulator capable of six degrees of freedom (6DOF) movement for manipulating and positioning the carrier, and a pneumatic or other mechanical subsystem for applying pressure or a suitable vacuum. Electromechanical subsystems facilitate configuration and movement of the carrier. Optical (imaging) and closed-loop electronic control subsystems interpret imaging and tracking data to calculate optimal component positioning and activation of the various subsystem components. The control system typically is enabled under programmatic control (hardware and software) to provide for semi-automated or fully guided control of the freezing protocol and the resulting storage and/or use of the frozen sample.

What is claimed follows below.

1. A method of sample preparation in association with an electron microscope, comprising:
receiving a carrier supporting a biological sample; and
applying to the carrier a high-pressure freezing (HPF) protocol comprising a first phase, and a second phase that follows the first phase;
the first phase comprising (i) a pressurizing operation applying a pressure to the carrier; and (ii) a rapid cooling operation using a coolant that avoids a Leidenfrost effect at a carrier-coolant interface by maintaining nucleate boiling or substantially suppressing film boiling upon contact with the carrier, wherein the pressurizing and rapid cooling operations freeze the biological sample while preserving its structural integrity;
the second phase raising a temperature of the carrier and the frozen biological sample to a given temperature for one of: storage, and use.

2. The method as described in claim 1, wherein the coolant is one of: liquid helium, liquid neon, slush nitrogen, liquid propane, and combinations thereof.

3. The method as described in claim 1, wherein the temperature is the temperature of liquid nitrogen.

4. The method as described in claim 1, wherein the pressure is in the range of 1800 – 2400 bar.

5. The method as described in claim 4, wherein the pressure is 2100 bar.

6. The method as described in claim 1, wherein the biological sample has a thickness up to 200μm thick.

7. The method as described in claim 1, wherein the biological sample has a thickness up to 300μm thick.

8. The method as described in claim 1, wherein the carrier is formed of silicon carbide (SiC).

9. The method as described in claim 1, wherein the carrier is formed of synthetic diamond.

10. The method as described in claim 1, wherein the pressurizing operation occurs before or concurrently with the rapid cooling operation.

11. The method as described in claim 1, further including performing one of: a structural study, a functional study, and a combination thereof, on the frozen biological sample.

12. The method as described in claim 1, wherien the coolant has a temperature at or below 120K and a specific heat capacity greater than that of liquid nitrogen.
